(19) United States
(12) Patent Application Publication
(10) Pub. No.: US 2012/0087259 A1
(43) Pub. Date: Apr. 12, 2012

(54) APPARATUS AND METHOD FOR COMMUNICATING MDT-RELATED DATA

(75) Inventors: Wang Chun KIM, Seoul (KR); Hyeon LEE, Seoul (KR); Hyun Joon JEON, Guri-si (KR); Jae Sam JUNG, Seongnam-si (KR); Yong Jun CHO, Seoul (KR); Hyun Soo CHO, Seoul (KR)

(73) Assignee: PANTECH CO., LTD., Seoul (KR)

(21) Appl. No.: 13/227,813

(22) Filed: Sep. 8, 2011

(30) Foreign Application Priority Data
Oct. 12, 2010 (KR) 10-2010-0099155

(51) Int. Cl. H04W 24/00; H04L 12/26

(52) U.S. Cl. 370/252

(57) ABSTRACT

Provided is a method for obtaining and reporting minimization of drive-tests (MDT)-related data and an apparatus for performing the same. The method may include receiving mode signaling message related to performing of an MDT mode, obtaining MDT-related data for measuring a propagation environment around equipment, based on the MDT mode signaling message, maintaining and storing the MDT-related data in a memory, generating an MDT report message including at least one of an average of the MDT-related data D_{Average} and information about distribution of the MDT-related data D_{Distribution}, and transmitting the MDT report message to a base station.

### CROSS-REFERENCE TO RELATED APPLICATION

This application claims priority from and the benefit under 35 U.S.C. §119(a) of Korean Patent Application No. 10-2010-0099155, filed on Oct. 12, 2010, which is hereby incorporated by reference for all purposes as if fully set forth herein.

### BACKGROUND

1. Field

Exemplary embodiments of the present invention relate to implementation of minimization of drive-tests (MDT), and more particularly, to an apparatus and a method for obtaining and reporting MDT-related data.

2. Discussion of the Background

According to radio communication standards, equipment may be used to store raw is logged data obtained for minimization of drive-tests (MDT) for a specific time. The MDT-related data may be data for measuring a propagation environment around a device. Raw logged data obtained for MDT may be stored in equipment until the raw logged data is reported to a network management system, thus each measurement may not be reported. Accordingly, equipment for supporting MDT may have memory for storing measured raw logged data.

Raw logged data obtained for MDT may be accumulated in a memory at each cycle. Equipment may transmit the raw logged data accumulated at each cycle to a base station or a network management system. Hereinafter, an apparatus for receiving a report of MDT-related data from equipment, for example, a network management system, a base station, and the like, is referred to as a system. In this instance, as MDT time increases, the accumulated raw logged data increases. As a result, an occupancy time of a channel between the user equipment and the system may increase as well. The system has a limited capacity for receiving data. As an occupancy time of a channel between the equipment and the system increases, thereby increasing data between the equipment and the system, the number of equipments able to be received in a system decreases.

### SUMMARY

The following description relates to equipment which may process data related to minimization of drive-tests (MDT) and report the processed data to a system, thereby reducing a waste of communication resources. Additional features of the invention will be set forth in the description which follows, and in part will be apparent from the description, or may be learned by practice of the invention.

An exemplary embodiment provides for a method to communicate minimization is of drive-tests (MDT)-related data associated with equipment, the method including receiving an MDT mode signaling message; measuring a propagation environment associated with the equipment to produce MDT-related data, after receiving the MDT mode signaling message; storing the MDT-related data; generating an MDT report message that comprises an average of the MDT-related data D_{Average} and/or information about distribution of the MDT-related data D_{Distribution}; and transmitting the MDT report message.

An exemplary embodiment provides for a method for communicating minimization of drive-tests (MDT)-related data associated with equipment, the method including receiving an MDT mode signaling message; determining whether a change of status from an original state to a new state based on communication of the equipment with a with a serving cell; measuring location information of the equipment associated with MDT-related data, if in a new state; generating an MDT report message including one of an average of the location information of the user equipment L_{Average} and information about distribution of the location information of the user equipment L_{Distribution}; and transmitting the MDT report message to a base station if the equipment returns back to the original state.

An exemplary embodiment provides for a method for communicating minimization of drive-tests (MDT)-related data, the method including generating an MDT mode signaling message based on one of mobility of an equipment and a received field strength of the equipment; transmitting the MDT mode signaling message to the equipment; and receiving an MDT report message that comprises one of an average of MDT-related data D_{Average} and information about distribution of MDT-related data D_{Distribution} from the equipment.

An exemplary embodiment provides for an equipment including a communication unit to receive a minimization of drive-tests (MDT) mode signaling message and to cause the equipment to enter MDT mode; a measuring unit to measure periodically MDT-related data during the MDT mode; a report message generating unit to generate an MDT report message that comprises one of an average of the MDT-related data D_{Average} and information about distribution of the MDT-related data D_{Distribution}; and a control unit to control the communication unit to transmit the MDT report message to a base station, wherein the MDT-related data is based on a propagation environment around the equipment.

An exemplary embodiment provides for an apparatus including a minimization drive-tests (MDT) mode signaling message generating unit to generate an MDT mode signaling message that instructs equipment to enter MDT mode based on one of a mobility of the equipment and a received field strength of the equipment; a transmitting unit to transmit the MDT mode signaling message to the equipment; and a receiving unit to receive an MDT report message that comprises one of an average of MDT-related data D_{Average} and information about distribution of MDT-related data D_{Distribution} from the equipment.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view illustrating an example of a radio environment according to an exemplary embodiment.

FIG. 2 is a view illustrating communicating MDT-related data according to an exemplary embodiment.

FIG. 3 is a block diagram illustrating equipment according to an exemplary embodiment.

FIG. 4 is a block diagram illustrating a structure of a control unit and a memory unit according to an exemplary embodiment.

FIG. 5 is a view illustrating memory configuration according to an exemplary embodiment.

FIG. 6 is a view illustrating memory configuration according to an exemplary embodiment.

FIG. 7 is a flowchart illustrating communicating MDT-related data according to an exemplary embodiment.

FIG. 8 is a flowchart illustrating communicating MDT-related data according to an exemplary embodiment.

FIG. 9 is a block diagram illustrating equipment according to an exemplary embodiment.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that for the purposes of this disclosure, “at least one of” will be interpreted to indicate any combination the enumerated elements following the respective language, including combinations of multiples of the enumerated elements. For example, “at least one of X, Y, and Z” will be construed to include X only, Y only, Z only, or any combination of two or more items X, Y, and Z (e.g., XYZ, XZ, YZ).

It will be understood that when an element is referred to as being “connected to” another element, it can be directly connected to the other element, or intervening elements may be present.

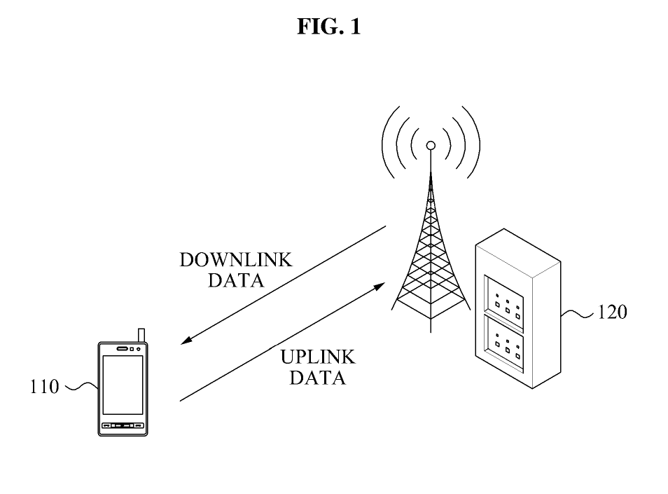

FIG. 1 is a view illustrating an example of a radio environment according to an exemplary embodiment.

Referring to FIG. 1, downlink data may be transmitted from a system 120 to an equipment 110. In this instance, downlink data may include a variety of signaling messages and traffic data. In the example of FIG. 1, uplink data is transmitted from equipment 110 to the system 120. In this instance, uplink data may include report data related to MDT. However, aspects are not limited thereto such that downlink data and uplink data may each include other types of data and signals transmitted between the system 120 and the equipment 110. As described above, the system 120 may encompass an apparatus, such as a network management system, a base station, and the like. In this disclosure, the base station may be, but is not limited to, an enhanced node B (EnB). That is, uplink data may be transmitted from the equipment 110 to a base station or a network management system. This transmission may depend on a configuration of a network.

The equipment 110 may transition to a state, such as detached, active, and idle, and power on. Here, the detached state may represent a state before the equipment 110 is registered, or enters, in a cell. The equipment 110 may obtain MDT-related data while in an idle state, and after the equipment 110 transitions to an active state, and may report the MDT-related data to the system 120. Also, the equipment 110 may obtain MDT-related data in an active state, and may report the MDT-related data to the system 120 in the active state. The equipment 110 may obtain the MDT-related data in an MDT mode. A cycle for measuring the MDT-related data may be, for example, 2 seconds. However, other times and durations may be used for the cycle. The MDT-related data may be data for measuring a propagation environment around the equipment 110. According to a radio communication standard, the equipment 110 may maintain or store parameters, for example, the parameters of the following Table 1, in a memory.

TABLE 1

| Parameters | Size | |
|---|---|---|
| Location information (Latitude/Longitude/ | 63 | bits |
| Altitude) | | |
| Time information (Month/Day/hour/Minute/ | 40 | bits |
| Second) | | |
| CGI (Cell Global Identity) of the serving cell | 52 | bits |
| (PLMN-id + Cell-id) | | |
| PCI(Physical Cell Identifier) of neighbour | 288 | bits |
| cells (×32) | | |
| Radio environment measurement (RSRP/RSRQ) | 429 | bits |
| for serving cell + neighbour cells (×32) | | |
| Total number of bits per log | 872 | bits |
| Total size of logs collected every 2 seconds | Around 4.7 | Mbytes |
| for 24 hours | | |

Referring to Table 1, data to measure a propagation environment of equipment may include location information of the equipment 110. That is, MDT-related data may include location information of the equipment, such as location information. Here, location information may be sorted into latitude, longitude, and altitude, and may be stored.

Also, MDT-related data may include information about a received field strength of equipment, such as reference signal received power (RSRP) for a serving cell or a neighbor cell. Herein, several examples are given as information that may be included with MDT-related data; however, the exemplary embodiments are not limited to these examples.

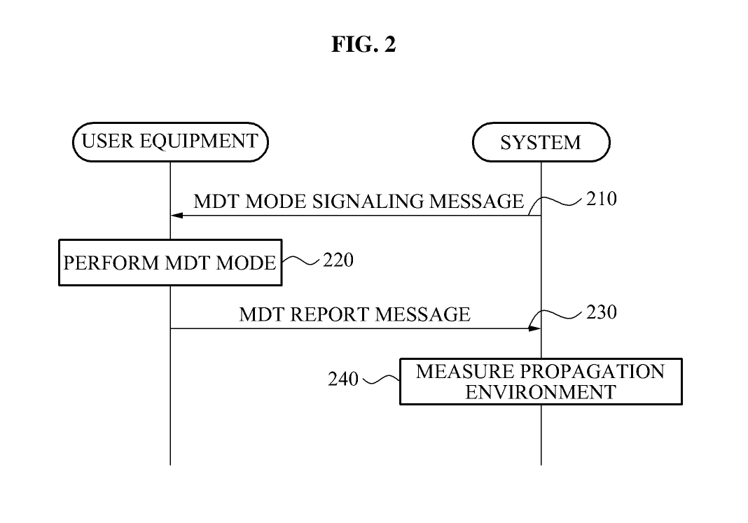

FIG. 2 is a view illustrating communicating MDT-related data according to an exemplary embodiment.

Referring to FIG. 2, in operation 210, the equipment may receive, from the system, an MDT mode signaling message related to performing of an MDT mode. In this instance, the MDT mode signaling message may include a type of MDT-related data to be measured and information about an MDT mode performing scheme. The MDT mode signaling message may include information about an MDT mode performing scheme and at least one of information about a measurement cycle of the MDT-related data, information about a storage architecture of the MDT-related data, information about a type of the MDT-related data, information about a reporting method of the MDT-related data, information about a reporting time of the MDT-related data, and information about a reporting cycle of the MDT-related data.

In operation 220, the equipment may operate in an MDT mode. If the performance of an MDT mode is completed, the equipment may generate an MDT report message. The MDT report message may include MDT-related data obtained during the MDT mode.

In operation 230, the user equipment may transmit the MDT report message to the system.

In operation 240, the system may measure a propagation environment or check the state of a network based on the received MDT report message.

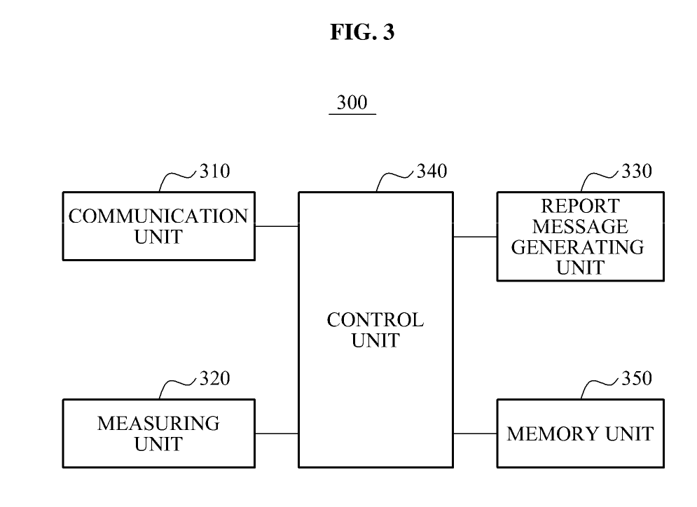

FIG. 3 is a block diagram illustrating equipment according to an exemplary embodiment.

Referring to FIG. 3, the equipment 300 may include a communication unit 310, a measuring unit 320, a report message generating unit 330, and a control unit 340. Also, the user equipment 300 may further include a memory unit 350.

The communication unit 310 may receive, from a system, an MDT mode signaling message related to performing of an MDT mode. In this instance, the MDT mode signaling message may include information about an MDT mode performing scheme and at least one of information about a measurement cycle of MDT-related data, information about a storage architecture of MDT-related data, information about a type of MDT-related data, information about a reporting method of MDT-related data, about a reporting time of MDT-related data, and information about a reporting cycle of MDT-related data.

If an MDT mode is performed, the measuring unit 320 may measure MDT-related data. That is, the measuring unit 320 may measure location information of the equipment 300 or received field strength of the equipment 300. Here, the received field strength of the equipment 300 may represent field strength of a signal received from a serving cell or a neighbor cell.

The report message generating unit 330 may generate an MDT report message which will be reported to a system. That is, the report message generating unit 330 may generate an MDT report message including at least one of an average of MDT-related data, DAverage, and information about distribution of MDT-related data, DDistribution.

In this instance, the MDT report message may include all, or part of raw data measured during an MDT mode. The MDT report message may include average distribution data obtained by processing raw data measured in an MDT mode. In this instance, the average distribution data may include an average of periodically measured MDT-related data. The average distribution data may include information about distribution of periodically measured MDT-related data. That is, the average distribution data may denote an average and a degree of distribution of raw data measured in an MDT mode, rather than raw data measured in an MDT mode. Accordingly, information about distribution of MDT-related data may include at least one of a maximum, a minimum, a variation, a standard deviation, and the number of periodically measured MDT-related data. In this instance, a measurement cycle of the MDT-related data may be, but not limited to, for example, 2 seconds.

The control unit 340 may control the communication unit 310 to transmit an MDT report message to a base station. As described above, the MDT report message may be transmitted from equipment to a base station due to the equipment being configured to communicate with the base station. The control unit 340 may control operation of the equipment 300, and may include at least one processor for this purpose.

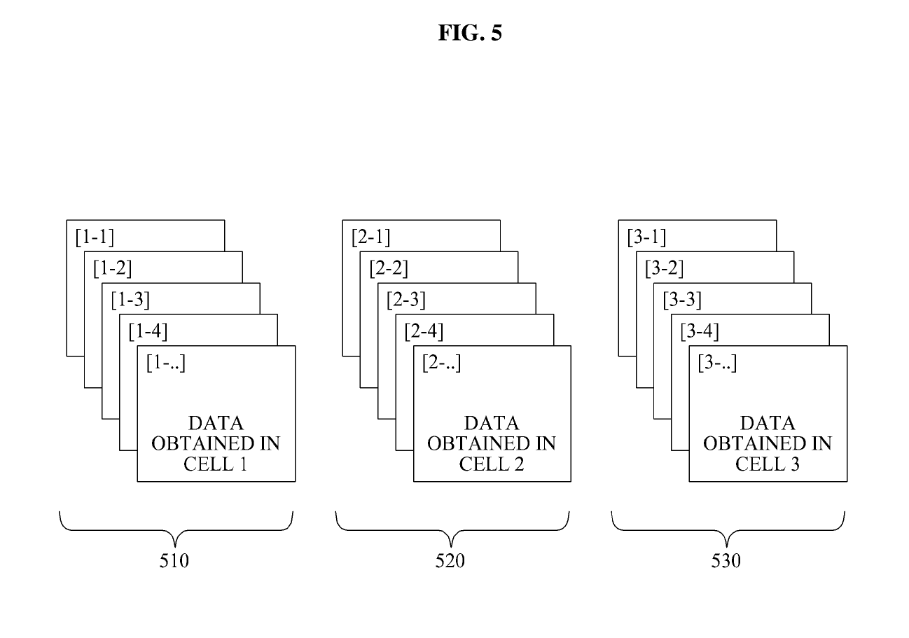

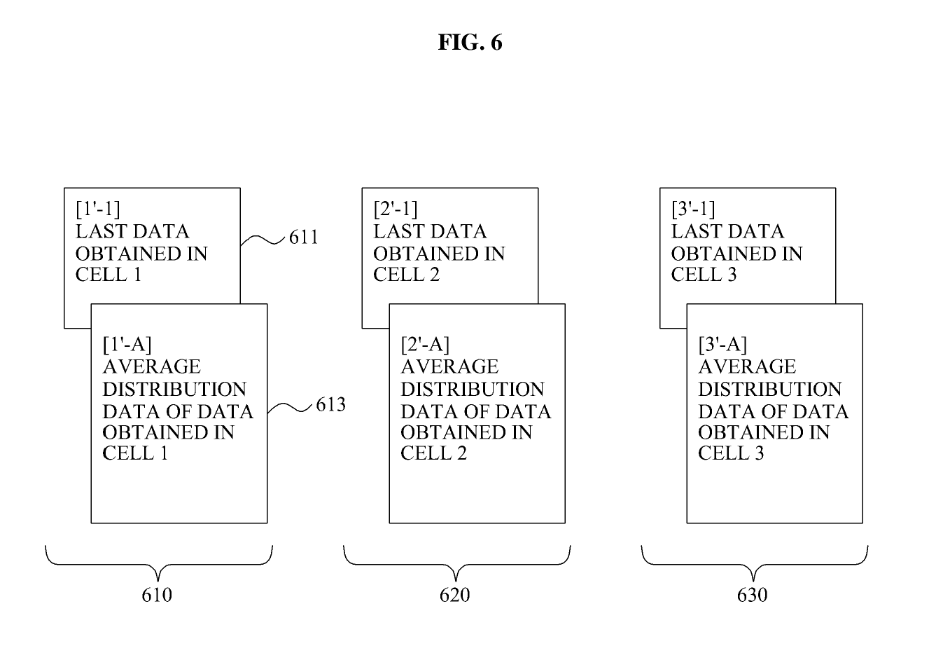

The memory unit 350 may maintain or record at least one of an average of periodically measured MDT-related data DAverage and information about a distribution of periodically measured MDT-related data DDistribution, if an MDT mode signaling message is received. Also, the memory unit 350 may maintain at least one of a memory configuration of FIG. 5 or a memory configuration of FIG. 6. A variety of memory configurations of the memory unit 350 are described below with reference to FIGS. 5 and 6.

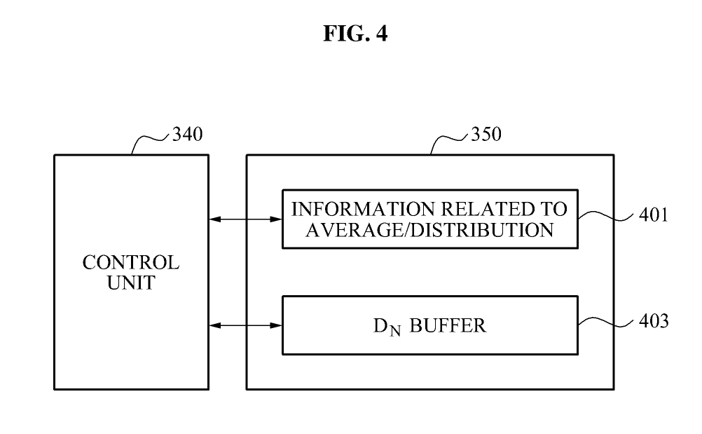

FIG. 4 is a block diagram illustrating a structure of the control unit 340 and the memory unit 350 according to an exemplary embodiment.

Referring to FIG. 4, the memory unit 350 may include an information area 401 related to an average or a distribution, and a D_{N} buffer 403.

The information area 401 related to the average or the distribution may store an average of MDT-related data DAverage and/or information about distribution of MDT-related data DDistribution.

The D_{N} buffer 403 may store D_{N} obtained from the measuring unit 320. The D_{N} buffer 403 may maintain values of D_{N} and D_{N}−1 obtained at TN−1 prior to a time TN. TN may refer to a current time.

The control unit 340 may update DAverage by using the stored D_{N} values in the information area 401. Also, the control unit 340 may update DDistribution by using the stored D_{N} values associated with the DDistribution in the information area 401.

To update the DAverage or the DDistribution with D_{N} values stored in the information area 401, the information area 401 related to the average or the distribution may contain a look-up table, for example, as shown in Table 2.

TABLE 2
Cell No. (serving cell) 1, 2, . . . M

| Maximum | Minimum | Variation | Average | Count | Maximum | Minimum | Variation | Average | Count |
|---|---|---|---|---|---|---|---|---|---|
| Location information (latitude) | | | | | Received field strength (serving cell) | | | | |
| 10 Bits | 10 Bits | 15 Bits | 10 Bits | 5 Bits | 10 Bits | 10 Bits | 15 Bits | 10 Bits | 5 Bits |
| Location information (longitude) | | | | | Received field strength (neighbor cell 1) | | | | |
| 10 Bits | 10 Bits | 15 Bits | 10 Bits | 5 Bits | 10 Bits | 10 Bits | 15 Bits | 10 Bits | 5 Bits |
| Location information (altitude) | | | | | Received field strength (neighbor cell 2) | | | | |
| 10 Bits | 10 Bits | 15 Bits | 10 Bits | 5 Bits | 10 Bits | 10 Bits | 15 Bits | 10 Bits | 5 Bits |

Referring to Table 2, count is the number corresponding to the amount of MDT-related data. That is, count of 100 indicates corresponding MDT-related data is measured 100 times. Accordingly, count increases by 1 whenever DAverage or DDistribution is updated.

Last data that is obtained recently in a corresponding cell, that is, stored as a D_{N} value, may be deleted from the memory unit 350 or may be maintained in the memory unit 350. If Last data obtained recently in a corresponding cell is set to be deleted, the control unit 340 may update at least one of DAverage and DDistribution and may delete D_{N} from the memory unit 350. Herein, last data may refer to the last item of data measured and/or the data most recently obtained. That is, the control unit 340 may update at least one of DAverage and DDistribution and may delete data stored in the D_{N} buffer 403.

FIG. 5 is a view illustrating memory configuration according to an exemplary embodiment.

Referring to FIG. 5, the memory unit 350 may store all or part of the periodically measured MDT-related data. That is, the user equipment may store the raw data measured in an MDT mode in the memory unit 350. In particular, if the user equipment moves to Cell 1, Cell 2, and Cell 3, the user equipment may separately maintain MDT-related data as data 510 obtained in the Cell 1, data 520 obtained in the Cell 2, and data 530 obtained in the Cell 3.

FIG. 6 is a view illustrating memory configuration according to an exemplary embodiment.

Referring to FIG. 6, a first memory area 610 stores MDT-related data obtained in Cell 1 in a processed form. The first memory area 610 may include an area where the Last data obtained recently in the Cell 1 is maintained, and an area where average distribution data of MDT-related data obtained at a previous time is maintained.

In the example of FIG. 6, a second memory area 620 stores MDT-related data obtained in Cell 2 in a processed form. That is, if the user equipment moves from the Cell 1 to the Cell 2 and remains connected with the Cell 2 for a specific time, the second memory area 620 may be maintained in the same configuration as the first memory area 610. In the example of HG. 6, a third memory area 630 stores MDT-related data obtained in Cell 3 is stored in a processed form.

The memory configuration of the memory unit 350 of FIG. 6 may be maintained if the equipment remains at the same location or within a specific range. Also, the memory configuration of the memory unit 350 of FIG. 6 may be maintained if the equipment is in a shadow area or a non-service area (areas not receiving reception). Also, the memory configuration of the memory unit 350 of FIG. 6 may be maintained based on an MDT mode signaling message received from a base station or other signal providing service.

If the memory unit 350 maintains the look-up table of Table 2, data to be transmitted if the user equipment transmits all, or part of raw data measured in an MDT mode to a system, and data to be transmitted if the user equipment transmits data processed as average distribution data to a system, may have a data size corresponding to the description below.

The following example assumes MDT-related data measured in an MDT mode is a received field strength.

The following example also assumes a memory capacity of 10 bits is used to record the received field strength. The following example further assumes the received field strength is obtained at the same location every 2 seconds for at least 24 hours. In this instance, if all, or part of raw data measured in an MDT mode is transmitted to a system, an amount of transmitted data is 432,000 bits, as shown in Formula 1. If data processed as average distribution data is transmitted, an amount of transmitted data is 60 bits, as shown in Formula 2.

Accordingly, the transmission of data processed as average distribution data may contribute to conserving communication resources.

10×60 (secs)×60(Minutes)×24(hours)/2 (secs)=432,000 Formula 1

Last data (10 bits)+Maximum (10 bits)+Minimum (10 bits)+Average (10 bits)+Variation (15 bits)+Count (5 bits)=60 bits Formula 2

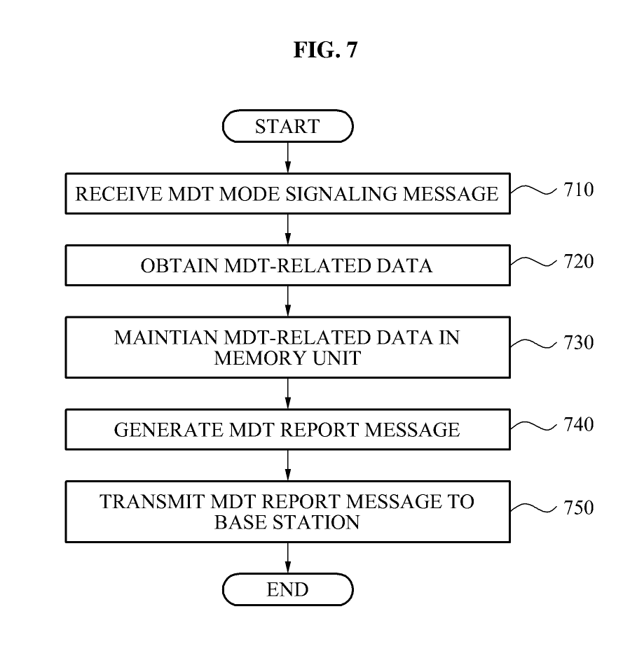

FIG. 7 is a flowchart illustrating communicating MDT-related data according to an exemplary embodiment.

The method of FIG. 7 may be performed by the equipment 300 of FIG. 3.

In operation 710, the equipment 300 may receive an MDT mode signaling message related to entering an MDT mode.

In operation 720, the equipment 300 may obtain MDT-related data based on the MDT mode signaling message.

In operation 730, the equipment 300 may store and maintain the MDT-related data in the memory unit. Here, the MDT-related data may be stored or maintained in a configuration described with either memory architecture described with reference to either FIG. 5 or FIG. 6; however, other memory configurations may be realized with the teachings of this disclosure. If the MDT-related data is stored or maintained in a configuration described with reference to FIG. 6, the operation 730 may further include the following operations.

1) The equipment 300 may store or maintain at least one of an average of the periodically measured MDT-related data DAverage and information about distribution of the periodically measured MDT-related data DDistribution, based on a parameter included in the MDT mode signaling message. Here, based on a parameter may describe obtaining MDT-related data designated in the parameter. Also, based on a parameter may describe obtaining MDT-related data based on a measurement cycle designated in the parameter. Also, based on a parameter may describe obtaining MDT-related data for a period of time designated in the parameter.

2) The equipment 300 may obtain MDT-related data D_{N} measured at a time TN. The time of the measurement may be a current time or correspond to another specific time.

The equipment 300 may update at least one of the DAverage and the DDistribution based on the D_{N} measured.

In operation 740, the equipment 300 may generate an MDT report message. The MDT report message may be generated by calculating average distribution data while maintaining all, or part of raw data as described with reference to FIG. 5. Further, the MDT report message may be generated while maintaining all raw data. Also, the MDT report message may be generated from the configuration of the memory unit 350 described with reference to FIG. 6. The MDT report message may include at least one of an average of the MDT-related data DAverage and information about distribution of the MDT-related data DDistribution. If the MDT-related data is stored or maintained in a configuration described with reference to FIG. 6, the operation 740 may further include the following operations.

1) The equipment 300 may check a reporting method of the MDT-related data included in the MDT mode signaling message.

2) If the reporting method includes at least one of DAverage and DDistribution, the user equipment 300 may calculate at least one of an average of the MDT-related data DAverage and information about distribution of the MDT-related data DDistribution.

3) The equipment 300 may generate an MDT report message including at least one of the DAverage and the DDistribution.

In operation 750, the equipment 300 may transmit the MDT report message to a base station.

In this instance, the transmitting of the MDT report message may be performed based on the reporting method of the MDT-related data included in the MDT mode signaling message.

If a reporting time of MDT-related data is designated in the MDT mode signaling message, the user equipment 300 may transmit the MDT report message at the reporting time of MDT-related data.

For example, the reporting method of MDT-related data may be designated as shown in Table 3.

TABLE 3

| Parameters | Designation |
|---|---|
| Reporting cycle | Reporting every 1 hour |
| Number of retries on | 3 times |
| transmission failure | |
| Processing method on | Retry to report in an in-service are |
| retry failure | |
| Reporting method 1 | Reporting all, or part of raw data |
| Reporting method 2 | Reporting an average of MDT-related data |
| Reporting method 3 | Reporting information about distribution |
| | of MDT-related data |
| Reporting method 4 | Reporting all, or part of information about |
| | an average and distribution |
| Method for treating raw data | Delete/maintain |
| Others | Changing an MDT mode performing |
| | scheme based on a predetermined |
| | condition |

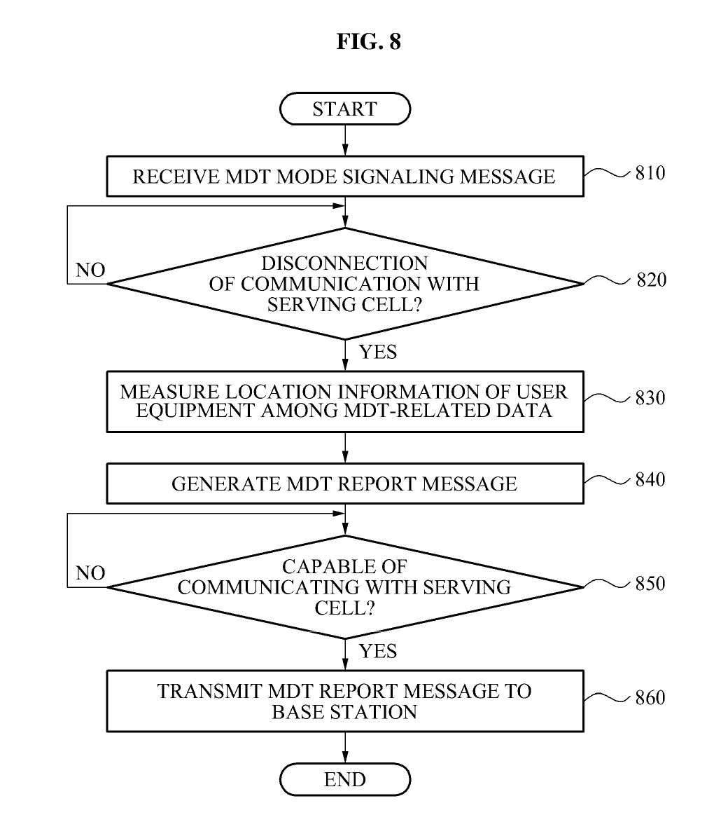

FIG. 8 is a flowchart illustrating communicating MDT-related data according to an exemplary embodiment.

The method of FIG. 8 may be performed by the equipment 300 of FIG. 3.

In operation 810, the equipment 300 may receive an MDT mode signaling message related to perform an MDT mode. The present exemplary embodiment assumes the MDT mode signaling message designates perform an MDT mode if disconnection of communication with a serving cell occurs.

In operation 820, the equipment 300 may check whether disconnection of communication with a serving cell has occurred.

In operation 830, if disconnection of communication with a serving cell has occurred, the equipment 300 may measure location information of the equipment 300 among MDT-related data. If disconnection of communication with a serving cell has occurred, the equipment 300 may not measure a received field strength. In this instance, a network operator may prefer to know information pertaining to which area is a non-service area. Accordingly, if disconnection of communication with a serving cell is determined to have occurred, the equipment 300 may periodically obtain location information by activating a location measuring process such as a global positioning system (GPS) receiver (not shown), and may store average accumulated distribution data of the obtained location information data in the memory unit.

In operation 840, the equipment 300 may generate an MDT report message including at least one of an average of the location information of the equipment L_{Average} and information about distribution of the location information of the equipment L_{Distribution}. The MDT report message may be generated by the method of FIG. 7.

In operation 850, the equipment 300 may determine whether the equipment 300 becomes capable of communicating with a serving cell.

If the equipment 300 is capable of communicating with a serving cell, the equipment 300 may transmit the MDT report message to a base station in operation 860.

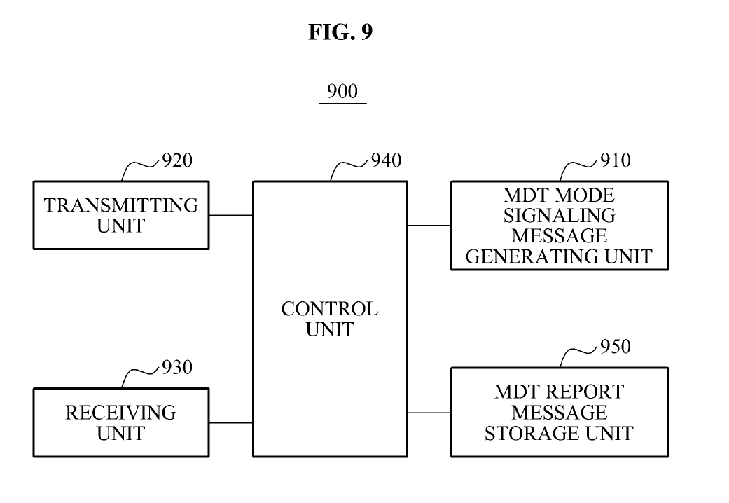

FIG. 9 is a block diagram illustrating equipment according to an exemplary embodiment.

The apparatus of FIG. 9 may be a network management system or a base station. Hereinafter, the present embodiment assumes the apparatus of FIG. 9 is a network management system 900, for ease of description.

Referring to FIG. 9, the network management system 900 may include an MDT mode signaling message generating unit 910, a transmitting unit 920, a receiving unit 930, a control unit 940, and an MDT report message storage unit 950.

The MDT mode signaling message generating unit 910 may generate an MDT mode signaling message related to performing an MDT mode with equipment that communicates with the network management system, based on at least one of mobility of the equipment and received field strength of the equipment. In this instance, the MDT mode signaling message generating unit 910 may generate an MDT mode signaling message by the control of the control unit 940.

The MDT mode signaling message may be set to be generated, including at least one of an average of MDT-related data D_{Average} and information about distribution of MDT-related data D_{Distribution}, if location information of the equipment is unchanged for a specific time and/or if the user equipment remains connected with the same serving cell for a specific time.

Also, the MDT mode signaling message may be set to store all, or part of periodically measured MDT-related data if a radio link failure occurs between the user equipment and a base station.

Also, the MDT mode signaling message may include group information from grouping of a plurality of equipment. The group information may be sorted into a first group set to generate an MDT report message including all, or part, of periodically measured MDT-related data and a second group set to generate an MDT report message including at least one of an average of MDT-related data D_{Average} and information about distribution of MDT-related data D_{Distribution}. That is, the network management system 900 may generate an MDT mode signaling message to separately generate an MDT report message for equipment in a stationary state and an MDT report message for equipment located in or at a specific area, because the network management system 900 may have the capabilities to recognize mobility and location information of equipment in real time.

Also, the MDT mode signaling message may be set to generate an MDT report message including all, or part of periodically measured MDT-related data and to generate an MDT report message including at least one of an average of the MDT-related data D_{Average} and information about distribution of the MDT-related data D_{Distribution}, depending on a received field strength of the user equipment. For example, if field strength of a signal received from the equipment is between −60 dBm and −90 dBm, the network management system 900 may set an MDT mode signal message to report average distribution data. If field strength of a signal received from the equipment is larger than −60 dBm, the network management system 900 may set an MDT mode signal message to generate an MDT report message including all, or part of periodically measured MDT-related data.

The transmitting unit 920 may transmit an MDT mode signaling message to equipment that communicates with the base station.

The receiving unit 930 may receive an MDT report message from an equipment. In this instance, the MDT report message may include at least one of an average of MDT-related data D_{Average} and information about distribution of MDT-related data D_{Distribution}.

The control unit 940 may control the entire operation of the network management system 900. In this instance, the control unit 940 may include at least one processor configured to control the entire operation of the network management system 900. Also, the control unit 940 may measure a propagation environment or may check the state of a network, based on a received MDT report message.

The MDT report message storage unit 950 may store an MDT report message received from equipment that communicates with the base station.

The network management system 900 may set an MDT mode performing scheme and a reporting method of MDT-related data in a user equipment, through a specific flag value included in an MDT mode signaling message.

For example, the network management system 900 may not perform an MDT mode or may terminate an MDT mode being performed by setting a flag value as 0. Also, the network management system 900 may set an MDT mode signaling message to report all, or part of MDT-related data obtained in the MDT mode, by setting a flag value as 1. Also, the network management system 900 may set an MDT mode signaling message to report average distribution data, by setting a flag value as 2.

Although not expressly shown in FIGS. 7 to 9, if the equipment receives a new MDT mode signaling message from a system during an MDT mode, the equipment may change an MDT mode performing scheme based on the new MDT mode signaling message. Accordingly, if the user equipment is in a stationary state, and moves to a boundary area between cells, the network management system 900 may change a flag value to 1 and transmit the changed flag value to the equipment. In this instance, the equipment may change an MDT mode performing scheme based on the flag value included in the new MDT mode signaling message.

Finally, an MDT mode signaling message and a flag value included in the MDT mode signaling message may be changed. Also, the MDT mode signaling message and the flag value included in the MDT mode signaling message may be maintained until a system transmits the changed information to an equipment. Accordingly, the MDT mode signaling message may be set for an equipment to perform an MDT mode by a specific method. In this instance, the MDT mode signaling message may include at least one of information about a measurement cycle of MDT-related data, information about storage architecture of MDT-related data, information about a type of MDT-related data, information about a reporting time of MDT-related data, and information about an MDT mode performing scheme.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media, such as hard disks, floppy disks, and magnetic tape; optical media, such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for communicating minimization of drive-tests (MDT)-related data associated with equipment, the method comprising:
receiving an MDT mode signaling message;
measuring a propagation environment associated with the equipment to produce MDT-related data, after receiving the MDT mode signaling message;
storing the MDT-related data;
generating an MDT report message that comprises an average of the MDT-related data D_{Average} and/or information about distribution of the MDT-related data D_{Distribution}; and
transmitting the MDT report message.

2. The method of claim 1, wherein the MDT mode signaling message comprises at least one of:
information about a measurement cycle of the MDT-related data,
information about a storage architecture of the MDT-related data,
information about a type of the MDT-related data,
information about a reporting method of the MDT-related data,
information about a reporting time of the MDT-related data,
information about a reporting cycle of the MDT-related data, and
information about an MDT mode performing scheme.

3. The method of claim 1, wherein the storing is preformed based on a parameter included in the MDT mode signaling message;
obtaining MDT-related data D_{N} measured at a current time T_{N}; and
updating the D_{Average} and/or the D_{Distribution} based on the MDT-related data D_{N}.

4. The method of claim 1, wherein the generating of the MDT report message comprises:
checking a reporting method based on the MDT mode signaling message;
calculating an average of the MDT-related data D_{Average} and information about distribution of the MDT-related data D_{Distribution} if the reporting method comprises one of the D_{Average} and the D_{Distribution}.

5. The method of claim 1, wherein the information about distribution of the MDT-related data D_{Distribution} comprises one of a maximum, a minimum, a variation, a standard deviation, and the number of the periodically measured MDT-related data.

6. A method for communicating minimization of drive-tests (MDT)-related data associated with equipment, the method comprising:
receiving an MDT mode signaling message;
determining whether a change of status from an original state to a new state based on communication of the equipment with a with a serving cell;
measuring location information of the equipment associated with MDT-related data, if in a new state;
generating an MDT report message including one of an average of the location information of the user equipment L_{Average} and information about distribution of the location information of the user equipment L_{Distribution}; and
transmitting the MDT report message to a base station if the equipment returns back to the original state.

7. A method for communicating minimization of drive-tests (MDT)-related data, the method comprising:
generating an MDT mode signaling message based on at least one of mobility of an equipment and a received field strength of the equipment;
transmitting the MDT mode signaling message to the equipment; and
receiving an MDT report message that comprises one of an average of MDT-related data D_{Average} and information about distribution of MDT-related data D_{Distribution} from the equipment.

8. The method of claim 7, wherein the MDT report message is generated if location information of the user equipment is unchanged for a time, or if the equipment remains connected with a same serving cell for a specific time.

9. The method of claim 7, wherein the method further comprises:
storing periodically measured MDT-related data if a radio link failure occurs between the equipment and a base station.

10. The method of claim 7, wherein the MDT mode signaling message is generated and transmitted for a plurality of equipment,
the MDT report message is received from the plurality of equipment, and
the MDT report message comprises group information, the group information having a first group that comprises periodically measured MDT-related data, and a second group that comprises one of an average of the MDT-related data D_{Average} and information about distribution of the MDT-related data D_{Distribution}.

11. The method of claim 7, wherein the MDT report message comprises periodically measured MDT-related data, or one of an average of the MDT-related data D_{Average} and information about distribution of the MDT-related data D_{Distribution}, based on a received field strength of the equipment.

12. An equipment, comprising:
a communication unit to receive a minimization of drive-tests (MDT) mode signaling message which causes the equipment to enter MDT mode;
a measuring unit to measure periodically MDT-related data during the MDT mode;
a report message generating unit to generate an MDT report message that comprises one of an average of the MDT-related data D_{Average} and information about distribution of the MDT-related data D_{Distribution}; and
a control unit to control the communication unit to transmit the MDT report message to a base station,
wherein the MDT-related data is based on a propagation environment around the equipment.

13. The equipment of claim 12, wherein the MDT mode signaling message comprises at least one of:
information about a measurement cycle of the MDT-related data,
information about a storage architecture of the MDT-related data,
information about a type of the MDT-related data,
information about a reporting method of the MDT-related data,
information about a reporting time of the MDT-related data,
information about a reporting cycle of the MDT-related data, and
information about an MDT mode performing scheme.

14. The equipment of claim 12, further comprising:
a memory unit to store one of an average of the periodically measured MDT-related data D_{Average} and information about distribution of the periodically measured MDT-related data D_{Distribution}.

15. The equipment of claim 12, wherein the information about distribution of the MDT-related data D_{Distribution} comprises at least one of a maximum, a minimum, a variation, a standard deviation, and the number of the periodically measured MDT-related data.

16. An apparatus, comprising:
a minimization drive-tests (MDT) mode signaling message generating unit to generate an MDT mode signaling message that instructs equipment to enter MDT mode based on one of a mobility of the equipment and a received field strength of the equipment;
a transmitting unit to transmit the MDT mode signaling message to the equipment; and
a receiving unit to receive an MDT report message that comprises one of an average of MDT-related data D_{Average} and information about distribution of MDT-related data D_{Distribution} from the equipment.

17. The apparatus of claim 16, wherein the MDT report message is generated, if location information of the equipment is unchanged for a time, or if the equipment remains connected with a same serving cell for a time.

18. The apparatus of claim 16, further comprising a memory unit to store periodically measured MDT-related data when a radio link failure occurs between the user equipment and a base station.

19. The apparatus of claim 16, wherein the transmitting unit transmits the MDT mode signaling message to a plurality of equipment and the receiving unit receives the MDT report message as group information,
the group information comprises a first group, the first group having the MDT-related data, and a second group, the second group having one of an average of the MDT-related data D_{Average} and information about distribution of the MDT-related data D_{Distribution}.

20. The apparatus of claim 16, wherein the MDT report message is generated based on a received field strength of the equipment.
